(19) United States
(12) Patent Application Publication
(10) Pub. No.: US 2003/0040918 A1
(43) Pub. Date: Feb. 27, 2003

(54) Data compression method

(76) Inventor: David F. Burrows, Godalming (GB)

Correspondence Address: FISH & NEAVE, 1251 AVENUE OF THE AMERICAS, 50TH FLOOR, NEW YORK, NY, 10020-1105, US

(21) Appl. No.: 09/939,350

(22) Filed: Aug. 24, 2001

(30) Foreign Application Priority Data
Aug. 21, 2001 (GB) 0120302.5

(51) Int. Cl. G10L 19/00

(52) U.S. Cl. 704/500

(57) ABSTRACT

A method of data compression coarsely codes components of data to be transmitted or processed where the ultimate recipient of those data are relatively insensitive to, or tolerant of, variations in that component. Thus, in data representing speech, the phase component, e.g., is more coarsely coded than, e.g., the amplitude component. In an extreme embodiment, the phase component may be coded by only one bit per sample, where that bit indicates whether the phase is advanced or retarded relative to a related sample, such as a previous or subsequent sample, while the amplitude may be coded by, e.g., 16 bits.

### BACKGROUND OF THE INVENTION

This invention relates to a method for compressing data. More particularly, this invention relates to a method for reducing the coding length of data that is transformed into components, where the recipient is more sensitive to one component than the other. Most particularly, this invention relates to reducing the coding length of data that have been subjected to Fourier transformation.

Many types of analog data are digitized for transmission and processing. As is well known, the digitized representations of such data more accurately reflect the original analog signal as the number of bits per sample increases. One example of such an analog signal is speech, which, particularly if being digitized for a purpose involving the reconstitution of an analog signal for playback to human listeners, ideally should be represented sufficiently accurately to be understandable and at least relatively undistorted at the listener's end.

The number of bits per sample required for suitable reproduction of, e.g., speech, is high, and runs up against bandwidth and other constraints. Therefore, ways are commonly sought to compress the digital data.

Moreover, a common and useful way of digitizing and transmitting an analog waveform, such as that representing speech or another physical phenomenon, is to subject the signal to Fourier transformation, such as by using a Fast Fourier Transform. The resulting transformed data are particularly well suited to processing and transmission. However, this actually compounds the compression problem, because M digital samples of the original analog waveform generate 2M transform coefficients (i.e., an M-sampled signal S(n) is transformed into 2M paired I/Q Fourier transform coefficients I(n) and Q(n)), doubling the coding length of the data.

It is apparent then, that it would be desirable to be able to reduce the coding length of Fourier transformed data.

### SUMMARY OF THE INVENTION

In accordance with the present invention, the coding length of M-sampled Fourier transformed data is reduced from 2M by as much as almost half by converting the Fourier transform coefficients into data representing magniture, or amplitude, of the original analog signal, and data representing the phase of the original analog signal.

The amplitude data preferably are transmitted at least substantially in their entirety. However, instead of transmitting the phase data in their entirety, a smaller number of bits is used to transmit the phase data. This could be done by quantizing the phase to a smaller number of values than the amplitude. A more extreme compression could be obtained by transmitting only a single bit indicating the phase difference between the current sample and a related sample such as the previous sample. The single bit preferably would indicate whether the phase is advanced or retarded by a fixed amount as compared to the related sample. The fixed amount would be determined in advance and would be “known” to the receiving apparatus for use in reconstructing the original signal.

The invention works for, e.g., speech, because empirical observation shows that human listeners are relatively insensitive to the phase of a speech waveform. The invention may also work for music, although a discerning listener may detect imperfections. The invention may further work for non-sound waveforms, depending on what aspect of the waveform is most sensitive to coding precision.

Thus, in accordance with the invention, there is provided a method for compressing data for transmission to a recipient. The method includes transforming the data into at least two components, where the recipient is tolerant of variations in one of the components. A compressed representation of that one component is transmitted. Preferably, the compressed representation is data representing the change of that component from a related sample, such as the previous sample.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a time-domain representation of a speech waveform;

FIG. 2 is a time-domain representation of a speech waveform created by digitizing the waveform of FIG. 1, quantizing it in the frequency domain using 2,000,001 possible phase values for each sample, and reconverting it to the time domain;

FIG. 3 is a time-domain representation of the difference (i.e., error) between the representation of FIG. 2 and the representation of FIG. 1;

FIG. 4 is a time-domain representation of a speech waveform created by digitizing the waveform of FIG. 1, quantizing it in the frequency domain using 15 possible phase values for each sample, and reconverting it to the time domain; and

FIG. 5 is a time-domain representation of the difference (i.e., error) between the representation of FIG. 4 and the representation of FIG. 1.

### DETAILED DESCRIPTION OF THE INVENTION

Empirical observation has shown that a human listener is relatively insensitive to phase errors during the playback of electronically processed speech signals. Therefore, in accordance with the present invention, speech signals that have been processed electronically, particularly those that have been transformed into a format that actually increases the amount of data to be transmitted or played back, can be compressed with little perceivable loss in quality by reducing the amount of phase data that are transmitted or played back. Although the invention is described with respect to phase, similar compression might be achieved by reducing the amount of data representing any component with respect to which a recipient is tolerant of, or less sensitive to, variations. Moreover, while the invention is described with respect to speech, other audio data, and even other analog non-audio data such as seismic activity recordings, that can be resolved into components, to variations in one of which the recipient is relatively insensitive, can be compressed in accordance with the invention.

In a preferred embodiment of the invention, a speech waveform is digitized by an analog-to-digital converter, preferably with 16-bit accuracy, preferably at a sample rate of 8 kHz—i.e., 8,000 16-bit samples preferably are collected each second, for a data rate in this preferred embodiment of 128,000 bits per second. These digitized speech data S(n) preferably are converted to the frequency domain through Fourier transformation, preferably using a Fast Fourier Transform. As a result, each 16-bit sample becomes two 16-bit Fourier transform coefficients I(n) and Q(n)—i.e., there are 16,000 16-bit coefficients, for a data rate of 256,000 bits per second in this preferred embodiment.

The coefficients are then converted into magniture, or amplitude, R(n) and phase P(n), as follows:

R(n)=((I(n))²+(Q(n))²)^{0.5}

P(n)=tan⁻¹(I(n)/Q(n))

The amplitude signal R(n) preferably is transmitted at least substantially in its entirety (i.e., at 128,000 bits per second in this embodiment). However, the phase signal P(n) preferably is compressed as described below.

Broadly considered, in accordance with the present invention, the phase signal P(n) is coarsely coded. For example, instead of transmitting sixteen bits per sample, only four bits per sample might be sent, and one method for deriving the four-bit values will be described below. Similarly, eight bits, or two bits, or any other number of bits fewer than sixteen bits could also be used to coarsely code the phase data. In the extreme as mentioned above, only one bit could be sent, indicating advance or retardation of the phase from a related sample, such as the previous sample. This method also will be discussed below.

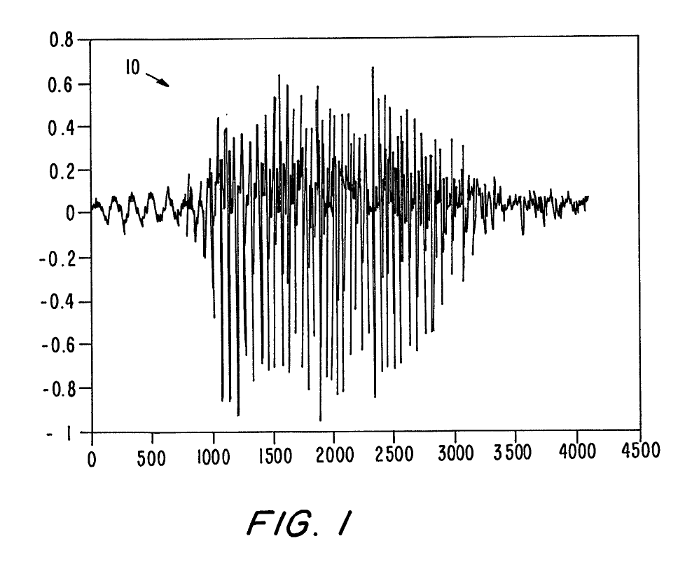

In a first example, the spoken word “hello” was recorded as a .WAV file. The original waveform 10 is plotted in FIG. 1 as a function of the amplitude (in volts) versus time (as represented by the sample number). The .WAV file was then processed, using the MATLAB® Signal Processing Toolbox signal analysis utility available from The MathWorks, Inc., of Natick, Mass., as follows:

First, the .WAV file was read into an array. Second, the time domain data in the array were converted to the frequency domain, in rectangular or Cartesian coordinates, using a Fast Fourier Transform. Next, the Cartesian frequency domain data were converted to polar coordinates, where the radius represented the magniture or amplitude, and the angle, ranging from −π to +π, represented the phase. The amplitude was transmitted with full precision.

Each phase sample was then quantized to one of a plurality of discrete values by selecting an integer N, normalizing the value of the phase sample to between −1 and +1 by dividing it by π, multiplying the normalized phase value by N, rounding the product to the nearest integer, dividing the rounded product by N and finally multiplying by π.

It will be appreciated that the rounded product of N and the normalized phase is an integer between −N and +N, which can have 2N+1 possible values (−N, . . . , −2, −1, 0, 1, 2, . . . , N). Dividing each of that many possible values by N and multiplying by π will not change the number of possible values. Therefore, the final result is that each phase sample is quantized to one of 2N+1 values. It will further be appreciated that the accuracy of the representation of the phase data by the quantization values increases as N increases.

Quantization was tried with N=1,000,000 (2,000,001 possible quantization values) and N=7 (15 possible quantization values). In each case the result, along with the full-precision amplitude data, was converted back to the time domain using an inverse Fast Fourier Transform, to produce a .WAV file that could be played back.

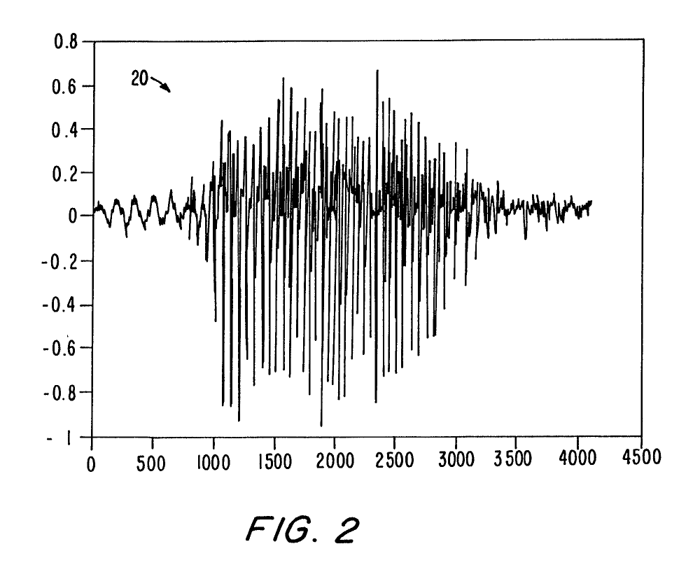

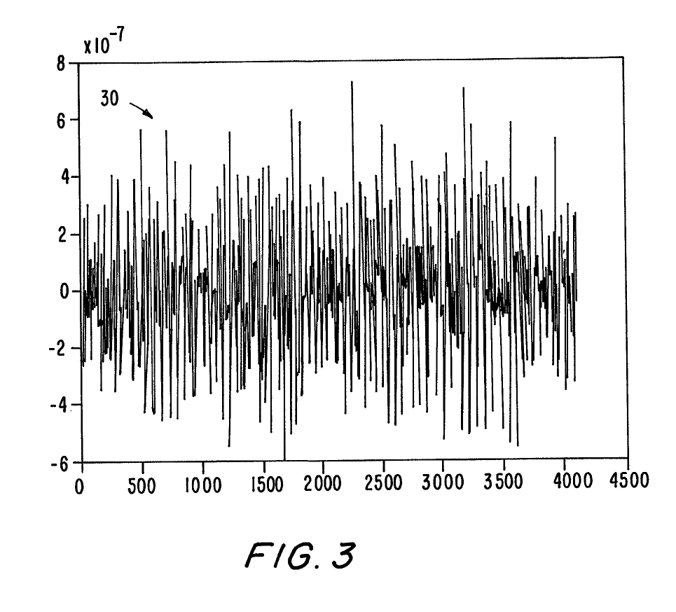

The resulting waveform 20 for the case where N=1,000,000 is plotted in FIG. 2 as a function of amplitude (in volts) versus time (as represented by the sample number). Visual comparison reveals that waveform 20 of FIG. 2 is virtually indistinguishable from original waveform 10 of FIG. 1. Empirically, it was observed upon playing back of the two .WAV files that to a human listener they were aurally indistinguishable as well. Indeed, the error 30 between waveform 20 and waveform 10, obtained by subtraction, is shown in FIG. 3, and has a maximum value of 8×10⁻⁷ volts.

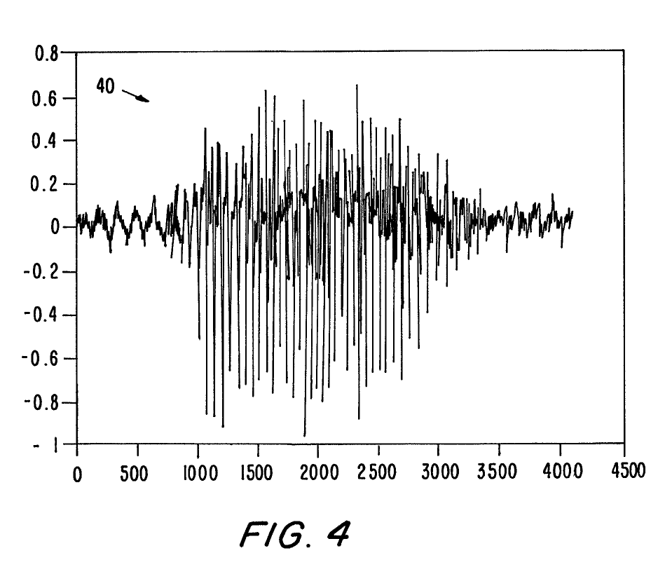

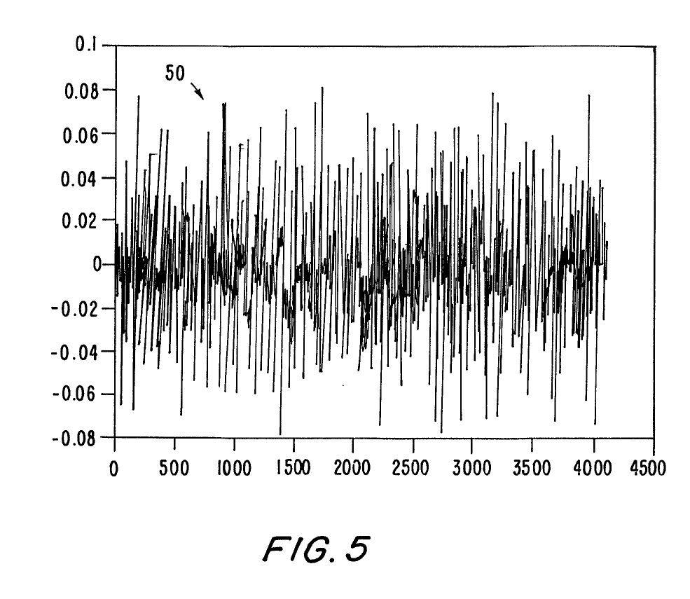

The resulting waveform 40 for the case where N=7 is plotted in FIG. 4 as a function of amplitude (in volts) versus time (as represented by the sample number). Visual comparison reveals that waveform 40 of FIG. 4 is similar to original waveform 10 of FIG. 1, but not so indistinguishable from waveform 10 as, e.g., waveform 20 was. Indeed, the error 50 between waveform 40 and waveform 10, obtained by subtraction, is shown in FIG. 5, and has a maximum value of close to 0.1 volts, or about 10% of the original signal. Nevertheless, it was observed empirically upon playing back of the resulting .WAV file that it sounded to a human listener virtually identical to the .WAV file represented by waveform 10.

Significantly, storage or transmission of the full precision Fourier-transformed signal typically would require 32 bits (16 bits for each of I(n), Q(n) or R(n), P(n) signal pairs). On the other hand, storage or transmission of waveform 40, which empirically sounds the same, would require only 20 bits (16 bits for R(n) and 4 bits for (P(n)).

In a second example, the spoken word “hello” again is recorded as a .WAV file (FIG. 1). The .WAV file is then processed, using the MATLAB® Signal Processing Toolbox signal analysis utility, as follows:

First, the .WAV file is read into an array as before. Second, as before, the time domain data in the array are converted to the frequency domain, in rectangular or Cartesian coordinates, using a Fast Fourier Transform. Next, the Cartesian frequency domain data are converted to polar coordinates, where, as above, the radius represents amplitude, and the angle represents phase. The amplitude is transmitted with full precision.

With respect to the phase, the value of the first (reference) sample preferably is set to zero. Thereafter, for each subsequent sample, a single bit preferably is transmitted, indicating whether the phase is advanced or retarded by some preferably fixed amount as compared to a related sample, which could be the previous sample, the next sample or another subsequent sample, the same sample in a previous or subsequent block of speech, or a sample related in some other predetermined way to the current sample. For example, a “1” could indicate that the phase is advanced while a “0” could indicate that the phase is retarded, or vice-versa. In a case where there is no change in the phase over several samples, the phase bits alternate between “1” and “0”, alternately advancing and retarding the phase by the same amount, so that on average there is no phase change.

The value of the “fixed amount” of phase change is determined empirically and “made known” in advance to the receiving/playback apparatus. The value must be small enough to produce acceptable fidelity (i.e., the value cannot be so large that the system does not register phase changes), but large enough to allow the system to respond (i.e., given that the value is fixed, the value cannot be so small that when a change is registered, the output change is insufficient to approximate the real change).

On the one hand, there is the question of how much of a phase change there has to be before the system reacts. On the other hand, if the system is to react, and is going to react by a fixed amount, then that fixed amount has to be some substantial portion of the full excursion of the phase data between the maximum and minimum phase values for the entire waveform. This requires knowing the likely maximum difference between phase samples. Depending on the system design, it may be that there is some known correlation between frequency samples. If so, it may be possible to select the same frequency sample from successive blocks of speech and encode only the difference in phase between them. Thus the invention likely would not work well for signals where there is little or no correlation between samples and the phase could assume any value from one sample to the next.

Another possibility may be to accumulate or “batch up” phase changes without transmitting them, either for a predetermined number of samples (e.g., covering 20 ms of speech data), or until the predetermined fixed amount is reached, and then to transmit the one or a few bits indicating that there is an increase or decrease of that amount (or no change if after a predetermined number of samples there is no net change).

If necessary, more than one bit could be used, to indicate by how many of the fixed increments the phase has changed. If one bit is used, the entire signal could be transmitted in this example using 17 bits instead of 32 bits, for a reduction by almost half of the full coding length. Generally speaking, the maximum expected difference between two phase values must be encodable by the largest value of the phase sample signal (which is a function of the number of bits used and the value of the increment the multiple of which they represent).

Any other compression scheme that takes advantage of listeners' relative insensitivity to phase variations in speech, or possibly other types of audio waveforms such as music, can be used. Similarly, if waveform data or any other type of data, such as seismic activity recordings, can be broken down into two or more components, where the recipient of the data is relatively tolerant of, or insensitive to, variations in one of those components, then in accordance with the invention, the data can be compressed by more coarsely coding that component to variations of which there is less sensitivity.

It should be noted that although the discussion above indicates that the amplitude data, or data representing any component to variations in which a recipient would be sensitive, is transmitted with full precision, or with at least substantially full precision, that is not meant to exclude the possibility that any data compressed by the method according to this invention might be further compressed by one of the well known general compression schemes commonly in use, such as MP3. Thus, in the speech examples set forth above, the output of the method according to this invention would be a full-precision (or substantially full-precision) amplitude signal and a compressed phase signal. That output could subsequently be subjected to one of the aforementioned general compression schemes as well.

At the receiving end, a signal compressed according to the present invention would be simply played back if compressed according to the first example, or, if compressed according to the second example, subject to reconstruction by advancing or retarding the phase for each sample as indicated by the compressed data, and then played back. If one of the aforementioned general compression schemes is used on the output of the method of this invention, then at the receiving end, the corresponding decompression scheme would be used first, and then the signal output by the present invention would be played back as just described.

Thus it is seen that the coding length of digitized data, particularly Fourier-transformed data, and particularly such data representing speech, can be decreased by up to almost half in accordance with the present invention. One skilled in the art will appreciate that the present invention can be practiced by other than the described embodiments, which are presented for purposes of illustration and not of limitation, and the present invention is limited only by the claims which follow.

What is claimed is:

1. A method for compressing data for transmission to a recipient, said method comprising:
transforming said data into at least two components, said recipient tolerant of variations in one of said components; and
transmitting a compressed representation of said one of said components.

2. The method of claim 1 wherein said compressed representation indicates a relative value of a current sample of said one of said components as compared to a related sample of said one of said components.

3. The method of claim 2 wherein said related sample is a previous sample.

4. The method of claim 2 wherein said previous sample is an immediately preceding sample.

5. The method of claim 4 wherein said relative value is one of (a) no change, (b) an increase by a predetermined increment, and (c) a decrease by said predetermined increment.

6. The method of claim 5 wherein said relative value is represented by one bit.

7. The method of claim 6 wherein said one of said components is phase.

8. The method of claim 7 wherein said transforming comprises applying a Fourier transformation.

9. The method of claim 8 wherein said data represent sound.

10. The method of claim 9 wherein said sound is speech.

11. The method of claim 7 wherein said data represent sound.

12. The method of claim 11 wherein said sound is speech.

13. The method of claim 2 wherein said related sample is a subsequent sample.

14. The method of claim 13 wherein said relative value is one of (a) no change, (b) an increase by a predetermined increment, and (c) a decrease by said predetermined increment.

15. The method of claim 14 wherein said relative value is represented by one bit.

16. The method of claim 15 wherein said one of said components is phase.

17. The method of claim 16 wherein said transforming comprises applying a Fourier transformation.

18. The method of claim 17 wherein said data represent sound.

19. The method of claim 18 wherein said sound is speech.

20. The method of claim 16 wherein said data represent sound.

21. The method of claim 20 wherein said sound is speech.

22. The method of claim 3 wherein said relative value is one of (a) no change, (b) an increase by a predetermined increment, and (c) a decrease by said predetermined increment.

23. The method of claim 22 wherein said relative value is represented by one bit.

24. The method of claim 23 wherein said one of said components comprises phase.

25. The method of claim 24 wherein said transforming comprises applying a Fourier transformation.

26. The method of claim 25 wherein said data represent sound.

27. The method of claim 26 wherein said sound is speech.

28. The method of claim 24 wherein said data represent sound.

29. The method of claim 28 wherein said sound is speech.

30. The method of claim 2 wherein said relative value is one of (a) no change, (b) an increase by a predetermined increment, and (c) a decrease by said predetermined increment.

31. The method of claim 30 wherein said relative value is represented by one bit.

32. The method of claim 31 wherein said one of said components comprises phase.

33. The method of claim 32 wherein said transforming comprises applying a Fourier transformation.

34. The method of claim 33 wherein said data represent sound.

35. The method of claim 34 wherein said sound is speech.

36. The method of claim 32 wherein said data represent sound.

37. The method of claim 36 wherein said sound is speech.

38. The method of claim 1 wherein said one of said components comprises phase.

39. The method of claim 38 wherein said transforming comprises applying a Fourier transformation.

40. The method of claim 39 wherein said data represent sound.

41. The method of claim 40 wherein said sound is speech.

42. The method of claim 38 wherein said data represent sound.

43. The method of claim 42 wherein said sound is speech.

44. The method of claim 1 wherein said transforming comprises applying a Fourier transformation.

45. The method of claim 44 wherein said data represent sound.

46. The method of claim 45 wherein said sound is speech.

47. The method of claim 1 wherein:
said recipient is sensitive to variations in another of said components; and
said method further comprises:
transmitting said another of said components at least substantially in its entirety.

48. The method of claim 47 wherein said one of said components is phase.

49. The method of claim 48 wherein said another of said components comprises amplitude.

50. The method of claim 49 wherein said compressed representation indicates a relative value of a current sample of said one of said components as compared to a related sample of said one of said components.

51. The method of claim 50 wherein said related sample is a subsequent sample.

52. The method of claim 51 wherein said relative value is one of (a) no change, (b) an increase by a predetermined increment, and (c) a decrease by said predetermined increment.

53. The method of claim 52 wherein said relative value is represented by one bit.

54. The method of claim 53 wherein said one of said components is phase.

55. The method of claim 54 wherein said transforming comprises applying a Fourier transformation.

56. The method of claim 55 wherein said data represent sound.

57. The method of claim 56 wherein said sound is speech.

58. The method of claim 54 wherein said data represent sound.

59. The method of claim 58 wherein said sound is speech.

60. The method of claim 50 wherein said related sample is a previous sample.

61. The method of claim 60 wherein said previous sample is an immediately preceding sample.

62. The method of claim 61 wherein said relative value is one of (a) no change, (b) an increase by a predetermined increment, and (c) a decrease by said predetermined increment.

63. The method of claim 62 wherein said relative value is represented by one bit.

64. The method of claim 63 wherein said transforming comprises applying a Fourier transformation.

65. The method of claim 64 wherein said data represent sound.

66. The method of claim 65 wherein said sound is speech.

67. The method of claim 64 wherein said data represent sound.

68. The method of claim 67 wherein said sound is speech.

69. The method of claim 60 wherein said relative value is one of (a) no change, (b) an increase by a predetermined increment, and (c) a decrease by said predetermined increment.

70. The method of claim 69 wherein said relative value is represented by one bit.

71. The method of claim 70 wherein said transforming comprises applying a Fourier transformation.

72. The method of claim 71 wherein said data represent sound.

73. The method of claim 72 wherein said sound is speech.

74. The method of claim 70 wherein said data represent sound.

75. The method of claim 74 wherein said sound is speech.

76. The method of claim 50 wherein said relative value is one of (a) no change, (b) an increase by a predetermined increment, and (c) a decrease by said predetermined increment.

77. The method of claim 76 wherein said relative value is represented by one bit.

78. The method of claim 77 wherein said transforming comprises applying a Fourier transformation.

79. The method of claim 78 wherein said data represent sound.

80. The method of claim 79 wherein said sound is speech.

81. The method of claim 78 wherein said data represent sound.

82. The method of claim 81 wherein said sound is speech.

83. The method of claim 49 wherein said transforming comprises applying a Fourier transformation.

84. The method of claim 83 wherein said data represent sound.

85. The method of claim 84 wherein said sound is speech.

86. The method of claim 83 wherein:
said one of said components is represented by a first number of bits; and
said another of said components is represented by a second number of bits greater than said first number of bits.

87. The method of claim 86 wherein said first number of bits is one.

88. The method of claim 48 wherein said transforming comprises applying a Fourier transformation.

89. The method of claim 88 wherein said data represent sound.

90. The method of claim 89 wherein said sound is speech.

91. The method of claim 88 wherein:
said one of said components is represented by a first number of bits; and
said another of said components is represented by a second number of bits greater than said first number of bits.

92. The method of claim 91 wherein said first number of bits is one.

93. The method of claim 48 wherein said compressed representation indicates a relative value of a current sample of said one of said components as compared to a related sample of said one of said components.

94. The method of claim 93 wherein said previous sample is an immediately preceding sample.

95. The method of claim 94 wherein said relative value is one of (a) no change, (b) an increase by a predetermined increment, and (c) a decrease by said predetermined increment.

96. The method of claim 95 wherein said relative value is represented by one bit.

97. The method of claim 96 wherein said one of said components is phase.

98. The method of claim 97 wherein said transforming comprises applying a Fourier transformation.

99. The method of claim 98 wherein said data represent sound.

100. The method of claim 99 wherein said sound is speech.

101. The method of claim 97 wherein said data represent sound.

102. The method of claim 101 wherein said sound is speech.

103. The method of claim 93 wherein said related sample is a previous sample.

104. The method of claim 103 wherein said previous sample is an immediately preceding sample.

105. The method of claim 104 wherein said relative value is one of (a) no change, (b) an increase by a predetermined increment, and (c) a decrease by said predetermined increment.

106. The method of claim 105 wherein said relative value is represented by one bit.

107. The method of claim 106 wherein said transforming comprises applying a Fourier transformation.

108. The method of claim 107 wherein said data represent sound.

109. The method of claim 108 wherein said sound is speech.

110. The method of claim 106 wherein said data represent sound.

111. The method of claim 110 wherein said sound is speech.

112. The method of claim 103 wherein said relative value is one of (a) no change, (b) an increase by a predetermined increment, and (c) a decrease by said predetermined increment.

113. The method of claim 112 wherein said relative value is represented by one bit.

114. The method of claim 113 wherein said transforming comprises applying a Fourier transformation.

115. The method of claim 114 wherein said data represent sound.

116. The method of claim 115 wherein said sound is speech.

117. The method of claim 113 wherein said data represent sound.

118. The method of claim 117 wherein said sound is speech.

119. The method of claim 93 wherein said relative value is one of (a) no change, (b) an increase by a predetermined increment, and (c) a decrease by said predetermined increment.

120. The method of claim 119 wherein said relative value is represented by one bit.

121. The method of claim 120 wherein said transforming comprises applying a Fourier transformation.

122. The method of claim 121 wherein said data represent sound.

123. The method of claim 122 wherein said sound is speech.

124. The method of claim 120 wherein said data represent sound.

125. The method of claim 124 wherein said sound is speech.

126. The method of claim 47 wherein said compressed representation indicates a relative value of a current sample of said one of said components as compared to a related sample of said one of said components.

127. The method of claim 126 wherein said related sample is a subsequent sample.

128. The method of claim 127 wherein said relative value is one of (a) no change, (b) an increase by a predetermined increment, and (c) a decrease by said predetermined increment.

129. The method of claim 128 wherein said relative value is represented by one bit.

130. The method of claim 129 wherein said one of said components is phase.

131. The method of claim 130 wherein said transforming comprises applying a Fourier transformation.

132. The method of claim 131 wherein said data represent sound.

133. The method of claim 132 wherein said sound is speech.

134. The method of claim 130 wherein said data represent sound.

135. The method of claim 134 wherein said sound is speech.

136. The method of claim 126 wherein said related sample is a previous sample.

137. The method of claim 136 wherein said previous sample is an immediately preceding sample.

138. The method of claim 137 wherein said relative value is one of (a) no change, (b) an increase by a predetermined increment, and (c) a decrease by said predetermined increment.

139. The method of claim 138 wherein said relative value is represented by one bit.

140. The method of claim 139 wherein said transforming comprises applying a Fourier transformation.

141. The method of claim 140 wherein said data represent sound.

142. The method of claim 141 wherein said sound is speech.

143. The method of claim 139 wherein said data represent sound.

144. The method of claim 143 wherein said sound is speech.

145. The method of claim 136 wherein said relative value is one of (a) no change, (b) an increase by a predetermined increment, and (c) a decrease by said predetermined increment.

146. The method of claim 145 wherein said relative value is represented by one bit.

147. The method of claim 146 wherein said transforming comprises applying a Fourier transformation.

148. The method of claim 147 wherein said data represent sound.

149. The method of claim 148 wherein said sound is speech.

150. The method of claim 146 wherein said data represent sound.

151. The method of claim 150 wherein said sound is speech.

152. The method of claim 126 wherein said relative value is one of (a) no change, (b) an increase by a predetermined increment, and (c) a decrease by said predetermined increment.

153. The method of claim 152 wherein said relative value is represented by one bit.

154. The method of claim 153 wherein said transforming comprises applying a Fourier transformation.

155. The method of claim 154 wherein said data represent sound.

156. The method of claim 155 wherein said sound is speech.

157. The method of claim 153 wherein said data represent sound.

158. The method of claim 157 wherein said sound is speech.

159. The method of claim 47 wherein said transforming comprises applying a Fourier transformation.

160. The method of claim 159 wherein said data represent sound.

161. The method of claim 160 wherein said sound is speech.

162. The method of claim 159 wherein:
said one of said components is represented by a first number of bits; and
said another of said components is represented by a second number of bits greater than said first number of bits.

163. The method of claim 162 wherein said first number of bits is one.

164. The method of claim 47 wherein:
said one of said components is represented by a first number of bits; and
said another of said components is represented by a second number of bits greater than said first number of bits.

165. The method of claim 164 wherein said first number of bits is one.

166. A method of compressing primary data and transmitting resultant compressed data to a recipient, said method comprising:
converting said primary data into secondary data; wherein:
said secondary data representing at least two components;
said recipient is relatively more tolerant of variations in one of said components as compared with variations in another of said components; and
said secondary data representing said one of said components is a relatively compressed representation as compared with said secondary data representing said another of said components; said method further comprising:
transmitting said secondary data to said recipient.

167. The method of claim 166 wherein said one of said components is phase.

168. The method of claim 167 wherein said another of said components comprises amplitude.

169. The method of claim 168 wherein said compressed representation indicates a relative value of a current sample of said one of said components as compared to a related sample of said one of said components.

170. The method of claim 169 wherein said related sample is a subsequent sample.

171. The method of claim 170 wherein said relative value is one of (a) no change, (b) an increase by a predetermined increment, and (c) a decrease by said predetermined increment.

172. The method of claim 171 wherein said relative value is represented by one bit.

173. The method of claim 172 wherein said one of said components is phase.

174. The method of claim 173 wherein said converting comprises applying a Fourier transformation.

175. The method of claim 174 wherein said data represent sound.

176. The method of claim 175 wherein said sound is speech.

177. The method of claim 173 wherein said data represent sound.

178. The method of claim 177 wherein said sound is speech.

179. The method of claim 169 wherein said related sample is a previous sample.

180. The method of claim 179 wherein said previous sample is an immediately preceding sample.

181. The method of claim 180 wherein said relative value is one of (a) no change, (b) an increase by a predetermined increment, and (c) a decrease by said predetermined increment.

182. The method of claim 181 wherein said relative value is represented by one bit.

183. The method of claim 182 wherein said converting comprises applying a Fourier transformation.

184. The method of claim 183 wherein said data represent sound.

185. The method of claim 184 wherein said sound is speech.

186. The method of claim 183 wherein said data represent sound.

187. The method of claim 186 wherein said sound is speech.

188. The method of claim 179 wherein said relative value is one of (a) no change, (b) an increase by a predetermined increment, and (c) a decrease by said predetermined increment.

189. The method of claim 188 wherein said relative value is represented by one bit.

190. The method of claim 189 wherein said converting comprises applying a Fourier transformation.

191. The method of claim 190 wherein said data represent sound.

192. The method of claim 191 wherein said sound is speech.

193. The method of claim 189 wherein said data represent sound.

194. The method of claim 193 wherein said sound is speech.

195. The method of claim 169 wherein said relative value is one of (a) no change, (b) an increase by a predetermined increment, and (c) a decrease by said predetermined increment.

196. The method of claim 195 wherein said relative value is represented by one bit.

197. The method of claim 196 wherein said converting comprises applying a Fourier transformation.

198. The method of claim 197 wherein said data represent sound.

199. The method of claim 198 wherein said sound is speech.

200. The method of claim 197 wherein said data represent sound.

201. The method of claim 200 wherein said sound is speech.

202. The method of claim 168 wherein said converting comprises applying a Fourier transformation.

203. The method of claim 202 wherein said data represent sound.

204. The method of claim 203 wherein said sound is speech.

205. The method of claim 202 wherein:
said one of said components is represented by a first number of bits; and
said another of said components is represented by a second number of bits greater than said first number of bits.

206. The method of claim 205 wherein said first number of bits is one.

207. The method of claim 167 wherein said converting comprises applying a Fourier transformation.

208. The method of claim 207 wherein said data represent sound.

209. The method of claim 208 wherein said sound is speech.

210. The method of claim 207 wherein:
said one of said components is represented by a first number of bits; and
said another of said components is represented by a second number of bits greater than said first number of bits.

211. The method of claim 210 wherein said first number of bits is one.

212. The method of claim 167 wherein said compressed representation indicates a relative value of a current sample of said one of said components as compared to a related sample of said one of said components.

213. The method of claim 212 wherein said previous sample is an immediately preceding sample.

214. The method of claim 213 wherein said relative value is one of (a) no change, (b) an increase by a predetermined increment, and (c) a decrease by said predetermined increment.

215. The method of claim 214 wherein said relative value is represented by one bit.

216. The method of claim 215 wherein said one of said components is phase.

217. The method of claim 216 wherein said converting comprises applying a Fourier transformation.

218. The method of claim 217 wherein said data represent sound.

219. The method of claim 218 wherein said sound is speech.

220. The method of claim 216 wherein said data represent sound.

221. The method of claim 220 wherein said sound is speech.

222. The method of claim 212 wherein said related sample is a previous sample.

223. The method of claim 222 wherein said previous sample is an immediately preceding sample.

224. The method of claim 223 wherein said relative value is one of (a) no change, (b) an increase by a predetermined increment, and (c) a decrease by said predetermined increment.

225. The method of claim 224 wherein said relative value is represented by one bit.

226. The method of claim 225 wherein said converting comprises applying a Fourier transformation.

227. The method of claim 226 wherein said data represent sound.

228. The method of claim 227 wherein said sound is speech.

229. The method of claim 225 wherein said data represent sound.

230. The method of claim 229 wherein said sound is speech.

231. The method of claim 222 wherein said relative value is one of (a) no change, (b) an increase by a predetermined increment, and (c) a decrease by said predetermined increment.

232. The method of claim 231 wherein said relative value is represented by one bit.

233. The method of claim 232 wherein said converting comprises applying a Fourier transformation.

234. The method of claim 233 wherein said data represent sound.

235. The method of claim 234 wherein said sound is speech.

236. The method of claim 232 wherein said data represent sound.

237. The method of claim 236 wherein said sound is speech.

238. The method of claim 212 wherein said relative value is one of (a) no change, (b) an increase by a predetermined increment, and (c) a decrease by said predetermined increment.

239. The method of claim 238 wherein said relative value is represented by one bit.

240. The method of claim 239 wherein said converting comprises applying a Fourier transformation.

241. The method of claim 240 wherein said data represent sound.

242. The method of claim 241 wherein said sound is speech.

243. The method of claim 239 wherein said data represent sound.

244. The method of claim 243 wherein said sound is speech.

245. The method of claim 166 wherein said compressed representation indicates a relative value of a current sample of said one of said components as compared to a related sample of said one of said components.

246. The method of claim 245 wherein said related sample is a subsequent sample.

247. The method of claim 246 wherein said relative value is one of (a) no change, (b) an increase by a predetermined increment, and (c) a decrease by said predetermined increment.

248. The method of claim 247 wherein said relative value is represented by one bit.

249. The method of claim 248 wherein said one of said components is phase.

250. The method of claim 249 wherein said converting comprises applying a Fourier transformation.

251. The method of claim 250 wherein said data represent sound.

252. The method of claim 251 wherein said sound is speech.

253. The method of claim 249 wherein said data represent sound.

254. The method of claim 253 wherein said sound is speech.

255. The method of claim 245 wherein said related sample is a previous sample.

256. The method of claim 255 wherein said previous sample is an immediately preceding sample.

257. The method of claim 256 wherein said relative value is one of (a) no change, (b) an increase by a predetermined increment, and (c) a decrease by said predetermined increment.

258. The method of claim 257 wherein said relative value is represented by one bit.

259. The method of claim 258 wherein said converting comprises applying a Fourier transformation.

260. The method of claim 259 wherein said data represent sound.

261. The method of claim 260 wherein said sound is speech.

262. The method of claim 258 wherein said data represent sound.

263. The method of claim 262 wherein said sound is speech.

264. The method of claim 255 wherein said relative value is one of (a) no change, (b) an increase by a predetermined increment, and (c) a decrease by said predetermined increment.

265. The method of claim 264 wherein said relative value is represented by one bit.

266. The method of claim 265 wherein said converting comprises applying a Fourier transformation.

267. The method of claim 266 wherein said data represent sound.

268. The method of claim 267 wherein said sound is speech.

269. The method of claim 265 wherein said data represent sound.

270. The method of claim 269 wherein said sound is speech.

271. The method of claim 245 wherein said relative value is one of (a) no change, (b) an increase by a predetermined increment, and (c) a decrease by said predetermined increment.

272. The method of claim 271 wherein said relative value is represented by one bit.

273. The method of claim 272 wherein said converting comprises applying a Fourier transformation.

274. The method of claim 273 wherein said data represent sound.

275. The method of claim 274 wherein said sound is speech.

276. The method of claim 272 wherein said data represent sound.

277. The method of claim 276 wherein said sound is speech.

278. The method of claim 166 wherein said converting comprises applying a Fourier transformation.

279. The method of claim 278 wherein said data represent sound.

280. The method of claim 279 wherein said sound is speech.

281. The method of claim 278 wherein:
said one of said components is represented by a first number of bits; and
said another of said components is represented by a second number of bits greater than said first number of bits.

282. The method of claim 281 wherein said first number of bits is one.

283. The method of claim 166 wherein:
said one of said components is represented by a first number of bits; and
said another of said components is represented by a second number of bits greater than said first number of bits.

284. The method of claim 283 wherein said first number of bits is one.
